(19) United States
(12) Patent Application Publication
(10) Pub. No.: US 2009/0183092 A1
(43) Pub. Date: Jul. 16, 2009

(54) CUSTOMIZABLE APPLICATION SYSTEM

(75) Inventor: Fazel Naghshineh, Kuala Lumpur (MY)

Correspondence Address: COLLEN IP, THE HOLYOKE MANHATTAN BUILDING, 80 SOUTH HIGHLAND AVENUE, OSSINING, NY, 10562, US

(73) Assignee: Britesoft Solutions (M) Sdn Bhd, Kuala Lumpur (MY)

(21) Appl. No.: 12/245,126

(22) Filed: Oct. 3, 2008

(30) Foreign Application Priority Data
Oct. 3, 2007 (MY) PI 20071696

(51) Int. Cl. G06F 3/048; G06F 17/30; G06F 21/20

(52) U.S. Cl. 715/762; 707/102; 707/10; 726/3; 707/E17.044; 707/E17.001; 707/E17.005

(57) ABSTRACT

A system comprises a data specifying builder to define a data model with specification stored in a repository usable for a customizable application, a process designing builder to define user interfaces and processes of the customizable application which include specified functions to access and manipulate data created by the data specifying builder, and an application deploying executor to generate application components using the data model designed by the process builder.

### FIELD OF INVENTION

The present invention relates generally to a computer processing system and more particularly to a customizable application system.

### BACKGROUND OF THE INVENTION

There are many software applications that have been developed to provide support for practices and processes needed for managing the operation of an organization. But due to variations in business operations of different types of industries, software applications are often packaged to suit a particular type of industry. Therefore it is difficult to find a packaged software application that perfectly match a particular company's operational needs.

Software development today is largely an art form based on craftsmanship. Everything is reinvented, resulting in duplication of effort and it is also tedious, time consuming, error prone and very expensive and as software becomes more complex, it further aggravates the situation. Currently, reuse and component based software development remains the most studied topic in software engineering. Virtually all initiatives in addressing the problem of software productivity are some variations of the reuse of software components. A common thread that runs through all the above approaches is a reliance on the traditional process-centered paradigm of producing code. They are all code-centric, focused on producing code, managing the code and looking at various levels of automation. The tools are focused on essentially automating as much as possible the identification and selection of the components. The developer still has to have sufficient knowledge of the internals of these components to adapt them to his specific needs.

Therefore the object of the present invention is to provide an improved system and method which allow for customization of a software application in an easy and efficient way.

Another object of the present invention is to provide the system which allows users to easily modify the generic application that suits their company's particular needs.

### SUMMARY OF THE INVENTION

In the present invention, a system comprising a data specifying builder to define a data model with specification stored in a repository usable for a customizable application, a process designing builder to define user interfaces and processes of the customizable application which include specified functions to access and manipulate data created by the data specifying builder, and an application deploying executor to execute application components using the data model designed by the process builder.

Preferably the data specifying builder comprises a drawer module for defining the data model to create a database for the customizable application. The drawer module further comprises the functions of performing syntactic validation and drawings windows from the user.

Preferably the process designing builder comprises a user interface engine module for identifying user interface for user to interact with the system to create application components of the customizable application which includes templates for user in specifying requirements with the data model using the drag and drop paradigm. The engine module translates information from repository, converts them into a suitable language and passes them to the drawer module

Preferably the application deploying executor comprises a business object layer to perform business logic on the data and data access layer to interact with the database engine for data transaction. This executor supports database and service oriented and interactive applications which can run on multi-tiered environment on the web and the desktop and on virtually any platform or database. The application deploying executor is also applicable to other mobile devices.

### BRIEF DESCRIPTION OF THE DRAWINGS

Other objects, features and advantages of the invention will be apparent from the following description when read with reference to the accompanying drawings. In the drawings, wherein like reference numerals denote corresponding parts throughout the several views:

FIG. 1 is a block diagram representing the components of the system of the present invention; and

FIG. 2 is a flowchart illustrating the development process for a customizable application in accordance with the present invention.

### DETAILED DESCRIPTION OF THE PREFERRED EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures and/or components have not been described in detail so as not to obscure the invention. Reference will now be made in detail to the preferred embodiments of the present invention, examples of which are illustrated in the accompanying drawings.

A software application is provided that allows a user to specify, customize interface and deploy database-oriented Web and Desktop applications. These applications are interactive for distributed and multi-tiered deployment. The present invention through the use of the technology described below is capable of creating enterprise applications in a fraction of the time and at a fraction of the cost of traditional development methods.

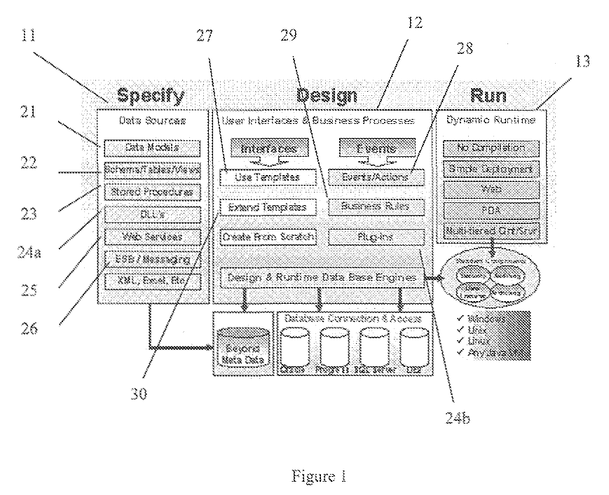

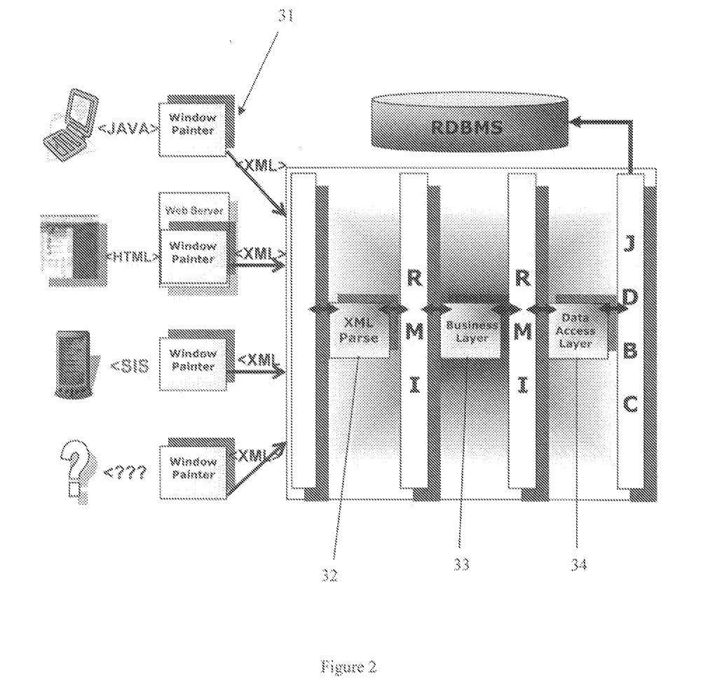

The working principle for the system of the present invention includes, but not limited to three major stages which are specifying data stage (11), designing process stage (12) and deploying application stage (13) as shown in FIG. 1. The specifying data stage (11) is configured to define a data model (21) for use by a customized software application. This specifying data stage (11) may includes definitions of various schema, tables or views (22), procedures (23), plug-ins (24), web services (25) as well as other services (26) or the like. In this stage, the user is concerned with all data bound objects. Specification is created to the system in a quick and easy manner and once created, the specification is held in the repository and can be accessed at any time. These specifications are stored in the repository as metadata. The customized software application (not shown) uses the metadata to execute an application instantly. Further metadata information can be added by the user to enrich the application and all information in the metadata is readily available for use by any part of the application.

Users may interface directly with a number of databases without having to know the syntax of the underlying database by using a database tool (not shown) provided at the specifying data stage (11). This makes it easier to deal with various database technologies as there is no need to learn individual database syntax, rather only the drag and drop paradigm of the system needs to be known. The database tool is used to create databases to the system which is done by creating an internal schema name in the schema, tables or views (22) and specifying the driver to be used and the connection string which points to the IP address of the database location. User is able to test the connection by specifying a userid and password. After a database is created to the system, a Metadata generator (not shown) accesses the database catalogue and generates information about the schema which will later be used by the system to create application components. The customized application can make use of services such as web services (25), messaging service (26), DLL's (24a) and other types of service oriented components. The output of one web service can be used to pass to the input of other services and update multiple types of databases.

The designing process stage (12) is configured to define user interfaces and business processes. These definitions include creating user interfaces to access and manipulate data created during the specifying data stage (11) by using templates (27) that guide the user in specifying requirements for example with the data model (21), defining events or actions (28), business rules (29), plug-ins (24b), workflow aspects, security or audit, layout of the interface pages and associate them together using the drag and drop paradigm rather than coding. As there is no code generation, these designs are instantly executable. Plug-ins (24b) provide a mechanism to write any level of custom code required which could be DLL's (24a), executable code, scripts or other languages. Java plug-ins are advisable as they fit better into the rest of the present invention's architecture and maintain platform independence. Events and actions (28) open up an application to any number of standard types of actions such as navigation, executing pre-defined events, populating data, etc. A group of actions and events (28) can be grouped together to form a local or global function. Events which are not pre-defined can still be written as a plug-in and used by the application.

Users can interact with the database through the user interfaces. User interface can be any device or combination of devices adapted for exchanging information between a user of user interface and other elements of the system. The business rules and events can be triggered through various controls (30) provided in a window design tool. Windows can be designed from scratch or any of a number of templates can be used which include all the standard functionality required to view and manipulate data. There are two types of business rules in the system namely rules that apply to database fields, for instance a status can only have certain permitted values and rules that can be applied to user interface controls, for instance a value in one field must be greater than another. The rules that are applied to controls are local to the window but the rules that are applied to database fields are global and apply to the filed in whichever window it appears.

The deploying application stage (13) is configured for execution of the customized software application where the metadata stored in the repository meet variety of business conditions. The customized software applications are modified to meet the needs without having to write additional software code. However, designs are instantly executable within the Studio allowing for instant gratification and functional testing. This system supports database and service oriented and interactive applications which can run as multi-tiered environment on the Web and the Desktop and on virtually any platform. There is no compilation of code, no source code control, no huge migration effort and certainly no balancing act between design and runtime. Other mobile devices such as Personal Digital Assistant device may also be used to access the application. Most of the security features are made available in the system server where roles can be defined by designated users, however, it is also made available in the designing process stage (12), in case access rights and security controls are not desired for any end user. Audit is also made available at the deploying application stage (13), however, again end users may not be given access to audit setup, where decisions on what data elements to be audited are made. The generic application that the end user has access to, where things like import or export, security, auditing etc are provided. The import and export facility allows users to define an import or export or both format for exchanging data with Excel, CSV files and eXtensible Markup Language (XML).

The system further includes a language and reporting tools. The customized software application has multi-lingual capability and translations can be written directly in the metadata and the runtime is sensitive to the orientation of the language. This capability allows users to dynamically define their own language text. By using the reporting tool, any level of detail and any kind of report can be made available to management and other users of the system who require formatted or graphical representation of the data.

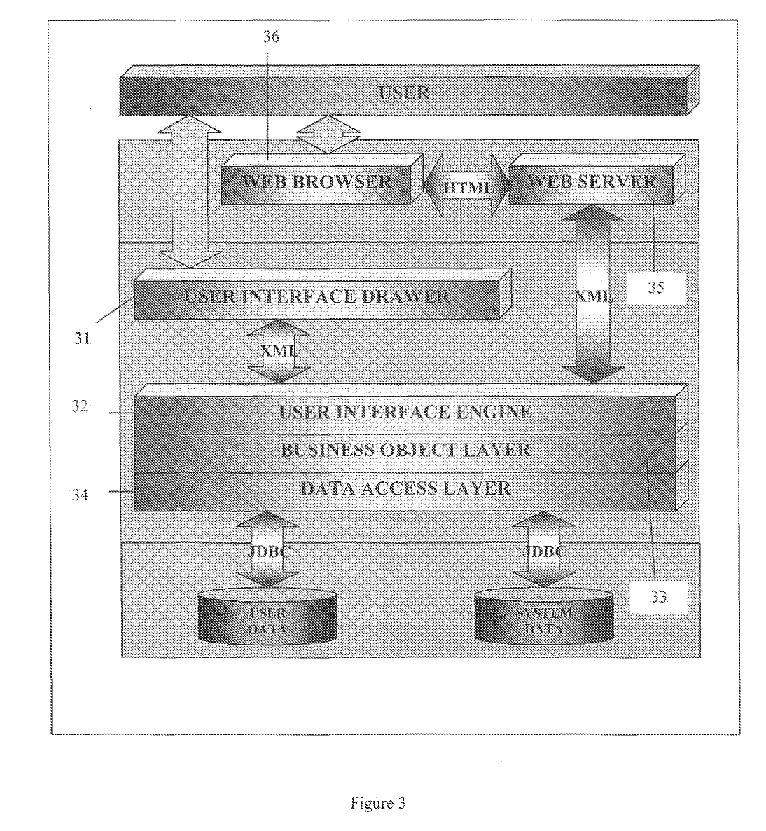

FIG. 2 depicts the present invention system architecture showing how the different modules interact with each other and allows the system to have a flexible deployment strategy. These modules are associated together in the system to function as a whole but these modules basically perform tasks uniquely and individually. They are preferably written using java language and can be deployed in many configurations that support java runtime environment and depending on the requirement. The configuration is chosen based on several factors such as the development requirement, runtime requirement, hardware requirement and security requirement as well as the number or users and servers. The modules include user interface drawer (31), user interface engine (32), business object layer (33) and data access layer (34). These modules can reside in a single environment or on multiple heterogeneous machines. They can run under the inventions own application server or under industry application or web servers such as JBOSS or Tomcat.

The user interface drawer module (31) works in connection with the user interface engine (32) for information transmission via XML. This module also enables and disables Graphical User Interface (GUI), performs syntactic validation and draws the windows from the XML for the user. The user interface engine (32) then translates information from database, converts them into XML and passes them to the user interface drawer (31). The user interface drawer (31) will then read the XML and convert them into data record to be inserted into the database. This user interface engine (32) works in connection with the business object layer (33) via Remote Method Invocation (RMI). The business object layer (33) performs business logic on the data and works in connection with the data access layer (34) via RMI. The data access layer (34) then interacts with the database engine via Java Database Connectivity (JDBC) where data transactions such as create, read, update and delete are done through this layer.

If the customized software application (14) is accessed through a browser, a web server layer (35) is required in the system. The user interface engine (32) sends the XML files to the web server layer (35) which is then converted into Hyper Text Transport Protocol (HTTP) and sent to requesting browser (36) using Javascript and AJAX. The business object layer (33) and data access layer (34) may be replaced by Java 2 Enterprise Edition (J2EE) or Enterprise Java Bean (EJB) if the target environment requires them.

As will be readily apparent to those skilled in the art, the present invention may easily be produced in other specific forms without departing from its essential characteristics. The present embodiment is, therefore, to be considered as merely illustrative and not restrictive, the scope of the invention being indicated by the claims rather than the foregoing description and all changes which come within therefore intended to be embraced therein.

1. A system comprising:
a data specifying builder to define a data model with specification stored in a repository usable for a customizable application;
a process designing builder to define user interfaces and processes of said customizable application which include specified functions to access and manipulate data created by said data specifying builder; and
an application deploying executor to generate application components using said data model designed by said process builder.

2. The system as claimed in claim 1, wherein said data specifying builder comprises a drawer module for defining said data model to create database for said customizable application.

3. The system as claimed in claim 2, wherein said database is created not limited to identifying name at a schema, specifying driver to be used and the connection string which points to an Internet Protocol address of a database location.

4. The system as claimed in claim 2, wherein said drawer module further comprises the functions of performing syntactic validation and drawing windows for the user.

5. The system as claimed in claim 1, wherein said process designing builder comprises a user interface engine module for identifying user interface for user to interact with the system to create application components of the customizable application.

6. The system as claimed in claim 5, wherein said user interface engine module includes templates for user in specifying requirements with the data model using the drag and drop paradigm with no code generation and therefore there is no compilation of code, no source code control, no huge migration effort and no balancing act between design and runtime.

7. The system as claimed in claim 6, wherein said interface engine module is in connection with said drawer module via Simple Object Access Protocol.

8. The system as claimed in claim 7, wherein said interface engine module translates information from repository, converts them into a suitable language and passes them to said drawer module

9. The system as claimed in claim 5, wherein said process designing builder further comprises a unit for defining events and actions for the customizable application, where a group of actions and events can be grouped together to form a local or global function.

10. The system as claimed in claim 9, wherein said process designing builder further comprises a unit for defining business rules for the customizable application.

11. The system as claimed in claim 10, wherein said business rules include rules which apply to database fields where a status can only have certain permitted values; and rules which apply to user interface controls where a value in one field must be greater than another.

12. The system as claimed in claim 10, wherein said process designing builder further comprises a unit for defining plug-ins for user to write events which are not pre-defined.

13. The system as claimed in claim 1, wherein said application deploying executor comprises a business object layer to perform business logic on the data and data access layer to interact with said database engine for data transaction.

14. The system as claimed in claim 13, wherein said business object layer is in connection with said user interface engine via Remote Method Invocation.

15. The system as claimed in claim 13, wherein said data access layer is in connection with said business object layer via Remote Method Invocation.

16. The system as claimed in claim 14, wherein said data access layer is in connection with said database engine via Java Database Connectivity.

17. The system as claimed in claim 13, wherein said application deploying executor supports database and service oriented and interactive applications which able to run on web and desktop applications as well as multi-tiered environment on the web and the desktop and on virtually any platform.

18. The system as claimed in claim 17, wherein said application deploying executor is also applicable to other mobile devices.

19. The system as claimed in claim 18, wherein said application deploying executor further comprises a unit for providing security access and audit controls for end user.

20. The system as claimed in claim 1, wherein said system further comprises a language and reporting tool which has multi-lingual capability and report can be made available to management and other users of the system.
